(19) United States
(12) Patent Application Publication
(10) Pub. No.: US 2010/0328489 A1
(43) Pub. Date: Dec. 30, 2010

(54) Lighting Control for HDR Camera

(75) Inventors: Jochen Bauer, Lindau (DE); Andre Rieder, Wasserburg (DE); Christoph Wiedemann, Wasserburg (Bodensee) (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hanover (DE)

(21) Appl. No.: 12/521,588

(22) PCT Filed: Dec. 4, 2007
(86) PCT No.: PCT/EP07/63248

§ 371 Date: Jun. 29, 2009

(30) Foreign Application Priority Data
Dec. 27, 2006 (DE) 10 2006 061 658.8

(51) Int. Cl. H04N 5/235

(52) U.S. Cl. 348/229.1; 348/E05.035

(57) ABSTRACT

A method for matching the sensitivity characteristic of an image converter to the light-intensity distribution of an optical image which is projected onto the photosensitive surface of the image converter. There are provided steps for creating a frequency distribution of the image signal values in the optical image converted by the image converter, for determining one or more quantiles of the frequency distribution of the image signal values, and for creating a adapted parameter set of setting values of the image converter on the basis of the specific quantile or quantiles of the frequency distribution.

The invention relates to the control of image converters, both those which have a linear sensitivity over the entire lighting range and those which have a high sensitivity at low lighting levels and low sensitivity at high lighting levels.

Image converters are used to convert optical images into image signals, which represent the optical image. Corresponding image converters are frequently also called image sensors. Optimum image results are obtained if the image information value contained in the image signals is maximal. This is the case if the image signals of an image completely exhaust the value range, which is the dynamic range of the image converter, available to them. In other words, optimization takes place in such a way that the signal values emitted by the individual image elements of the image converter in the case of a single image take up the entire signal range of the image converter from the minimal signal value to the maximal signal value. For simplified presentation the term ‘image’ will be used hereinafter for the entirety of the image signals, which each represent a specific optical image.

The conversion of the brightness values of an image element of the optical input image into a signal value or gray scale value of the output image is substantially determined by the sensitivity of the individual image converter elements. The sensitivity indicates the functional correlation between light intensity and output signal for an image converter element. The sensitivity of a linear or a logarithmic function can be formed depending on the construction of the image converter.

With linear sensitivity identical intensity differences are converted into identical image element output signal differences. In the case of very large differences in brightness within an optical image, relatively small variations in the light intensities are therefore barely still reflected in the associated image signals because matching the differences in the brightness of an optical image to the dynamic range of the image converter causes relatively small variations in brightness to be presented as reduced image signal differences as the differences in brightness increase. It is then often the case that it is no longer possible to discern any structures at all, primarily in the darker areas of the image.

This is particularly disadvantageous where image converters are used in motor vehicles, if the image converters are used by driving assistance systems which influence specific functions of the vehicle and under certain circumstances can even interfere in vehicle guidance. By way of example, a lane assistant can monitor the environment of a vehicle with the aid of the images obtained by an image converter and can intervene in the vehicle steering in the event of the risk of deviation from the road. In the case of tunnel entries and exits, sun reflecting on the road or cast shadow formation, the optical images projected onto the image converter generally have such extreme differences in brightness that the driving assistance system can often no longer identify the edge of the road.

With image converters having a logarithmic sensitivity characteristic the described drawbacks are overcome in that image conversion increasingly compresses differences in intensity in the upper brightness range. These image converters are very expensive, however.

Image converters with what is referred to as a lin-log characteristic have proven themselves as inexpensive alternatives in which the sensitivity characteristic is composed of two or more linear characteristic sections with different gradients. The sensitivity characteristic corresponds to a (multiply) inflected straight line whose gradient is lower in the range of relatively high lighting levels than in the range of relatively low lighting levels. Differences in intensity in the upper brightness range are therefore converted in a more compressed form than differences in intensity in the lower brightness range, whereby signal generation similar to logarithmic image conversion is achieved.

With lin-log image converters the sensitivity characteristic can be matched to a respective lighting situation via various control parameters. The control parameters are different in the different lin-log image converters and generally have reciprocal dependencies. They form a parameter set which can be functionally dealt with mathematically by means of a camera model.

A parameter set can, for example, be formed by a lighting time, amplification, offset, lin-log voltage(s) and lin-log time control, with lighting time and amplification causing a multiplicative scaling of the characteristic. The amplification also has effects on the offset and lin-log voltage(s), moreover. An offset brings about a displacement of the characteristic in the sense of an addition or subtraction of values. The height of the inflection point(s) is determined via the lin-log voltage(s) while the lin-log time control has an effect on the gradients of the individual characteristic sections.

The scenes detected by camera systems of a motor vehicle during driving operation frequently show a fast-changing dynamic, i.e. the differences in brightness within a scene detected by the respective camera system can change within the shortest time. This requires quick automatic matching of the sensitivity characteristic of the image converter used in the camera system to the changing brightness distribution within a few successive individual images.

The sensitivity characteristic is currently matched to the respective brightness distribution of the image projected onto the photosensitive surface of an image converter, i.e. the lighting control, by increasing or reducing the lighting time until the image comprises a certain number of saturated image signal values. The offset of the image is controlled in such a way that a defined gray scale value is attained for specific dark image elements and is then conventionally not changed any further. Apart from in the case of image converters with a linear or logarithmic sensitivity characteristic, this method is also used for image converters with a high-dynamic-range (HDR) functionality, the relative inflection points in the sensitivity characteristic being strictly specified. However the currently conventional matching of the sensitivity characteristic is too slow to obtain sufficient image contrasts within a few successive individual images in the case of fast-changing brightness situations as well.

It is therefore the object of the present invention to specify a method for quick and automatic matching of the sensitivity characteristic of an image converter to a changing brightness distribution within the optical image projected onto the image converter.

The object is achieved according to the independent claims of the invention.

The invention comprises a method for matching the sensitivity characteristic of an image converter to the light-intensity distribution of an optical image which is projected onto the photosensitive surface of the image converter, wherein the method has steps for the creation of a frequency distribution of the image signal values in the optical image converted by the image converter, for determination of one or more quantiles of the frequency distribution of the image signal values, and for creation of a matched parameter set of setting values of the image converter on the basis of the previously determined quantile or quantiles of the frequency distribution.

In this connection reference is made to the fact that the terms “comprise”, “have”. “contain”, “include” and “with”, and their grammatical modifications, used in this description and the claims to list features generally specify the presence of features, such as method steps, devices, ranges, sizes and the like for example, but do not in any way rule out the presence of other or further features or groups of other or further features.

The invention also comprises a device for matching the sensitivity characteristic of an image converter to the light-intensity distribution of an optical image which is projected onto the photosensitive surface of the image converter, comprising a histogram mechanism for creating a frequency distribution of the image signal values in the optical image converted by the image converter, a quantile determining device for determining one or more quantile(s) of the frequency distribution of the image signal values, and a setting calculation system for creating a matched parameter set of setting values of the image converter on the basis of the determined quantile or quantiles of the frequency distribution.

The invention also comprises a computer program product for matching the sensitivity characteristic of an image converter to the light intensity distribution of an optical image which is projected onto the photosensitive surface of the image converter, the computer program product comprising a series of physically distinguishable states which can be read and executed by a data processing system and which constitute a sequence of instructions which, executed on the data processing system, carry out a method corresponding to the above and produce the system of a device as specified above in the data processing system.

The invention allows extremely quick lighting control which makes it possible to correctly set the image converter as early as within the first or second successive image in the majority of cases.

The invention is developed in its dependent claims.

To be able to choose between various image converter operating modes the matched parameter set advantageously comprises at least one operating mode setting value for setting an operating mode of the image converter. For comprehensive lighting control the matched parameter set also advantageously comprises values for setting offset, lighting time and gain of the image converter.

To control the setting values of the image converter such that the frequency distribution of a successive image completely uses the dynamic range of the image converter, i.e. its available range of gray scale values, the matched parameter set of setting values is determined on the basis of a first quantile and a second quantile, the order of the second quantile being higher than the order of the first quantile.

To choose the image converter operating mode most advantageous to optimum image contrast the method preferably comprises a step for determining the operating mode setting value on the basis of at least one additional quantile. The order of the at least one additional quantile is preferably higher than the order of the first quantile and lower than the order of the second quantile in this case, so a change in the sensitivity of the image converter above a certain light intensity can be chosen.

According to an advantageous development of the invention the method comprises a step for determining the frequency distribution of the light intensities on the photosensitive surface of the image converter, determination taking place on the basis of a mathematical model of the conversion of a light intensity into an image signal with the actual setting values of the image converter as parameters. In a preferred development the matched parameter set of setting values of the image converter is advantageously created such that, based thereon, the mathematical model produces a matched frequency distribution from the previously determined frequency distribution of the light intensities, in which the first quantile corresponds to a first target value, the at least one additional quantile corresponds to an additional target value and the second quantile corresponds to a second target value.

To back-calculate to the light intensities of the optical image the setting calculation system preferably comprises a back-calculation system which is embodied to determine the frequency distribution of the light intensities on the photosensitive surface of the image converter, determination taking place on the basis of a mathematical model of the conversion of a light intensity into an image signal with the actual setting values of the image converter as parameters.

In a preferred embodiment the method comprises additional steps for comparing a quotient from the light intensity determined for the at least one additional quantile and the light intensity determined for the second quantile with a threshold value, and switching the image converter into a first operating mode if the quotient is greater than the threshold value, and switching the image converter into a second operating mode if the quotient is less than or equal to the threshold value. To carry out the comparison the setting calculation system expediently comprises a comparator for comparing the quotient with a threshold value.

Setting of the operating mode can advantageously be performed with the aid of an operating mode setting mechanism incorporated by the setting calculation system. An unequal distribution in the frequency of the gray scale values can be detected on the basis of the threshold value comparison and the image converter can advantageously be controlled in the operating mode in which more uniform distribution of the frequency of the grey scale values may be attained. Corresponding, fast matching to the lighting situation of the optical image can be achieved if the image converter has a linear sensitivity characteristic in the first operating mode and a sensitivity characteristic comprising at least two linear characteristic sections with different gradients in the second operating mode.

For lighting control of a lin-log image converter the matched parameter set expediently comprises values for setting the lin-log timing and lin-log voltage of the image converter, these setting values, in terms of quick lighting control, preferably being determined on the basis of the at least one additional quantile and the second quantile. For fast tracking of the lighting setting [of] an image converter, i.e. the fast generation of the matched parameter set, the values of the matched parameter set for setting offset, lighting time and gain of the image converter are preferably determined on the basis of the first quantile and the at least one additional quantile.

Further features of the invention emerge from the following description of exemplary embodiments according to the invention in connection with the claims and the figures. The individual features can be realized in an embodiment according to the invention individually in each case or multiply. In the following description of some exemplary embodiments of the invention reference will be made to the accompanying figures, in which:

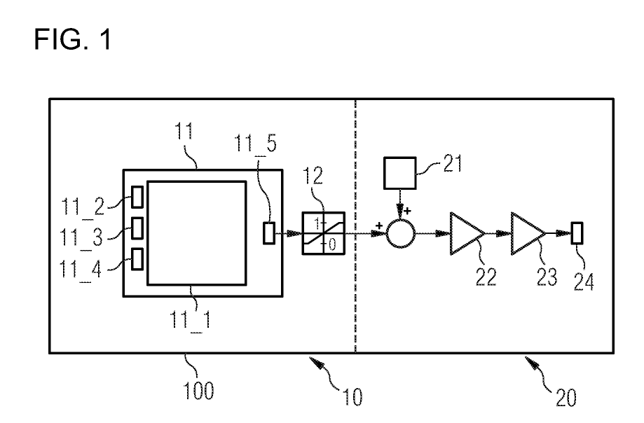

FIG. 1 shows the construction of an image converter with a CMOS chip,

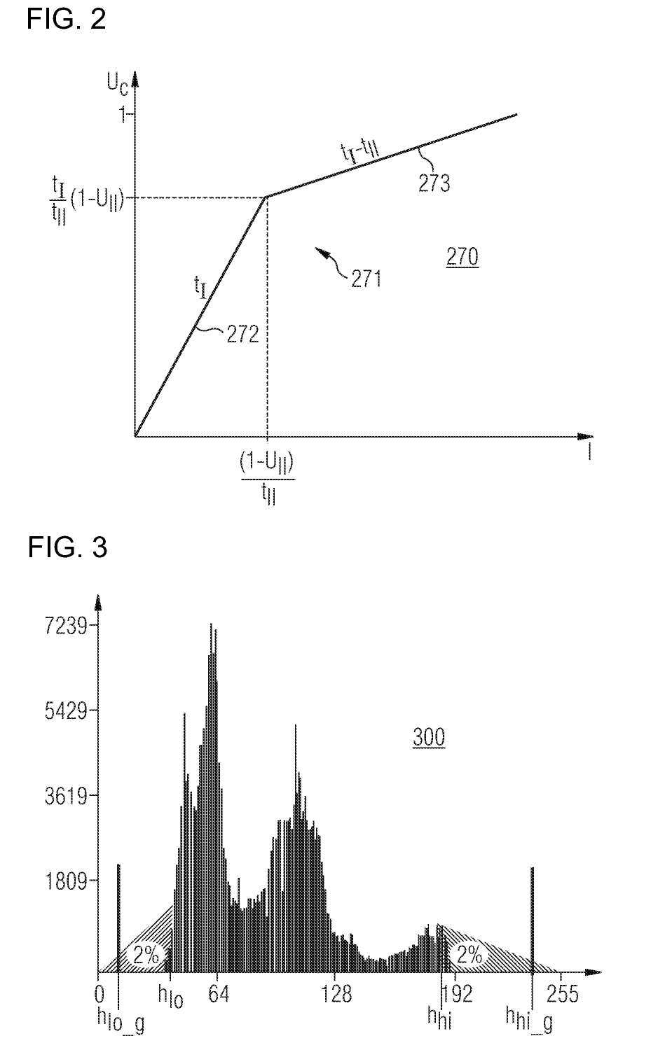

FIG. 2 shows a sensitivity characteristic of an image converted operated in lin-log mode,

FIG. 3 shows a histogram of gray scale values with the actual values and the target values for the 0.02 and 0.98 quantile,

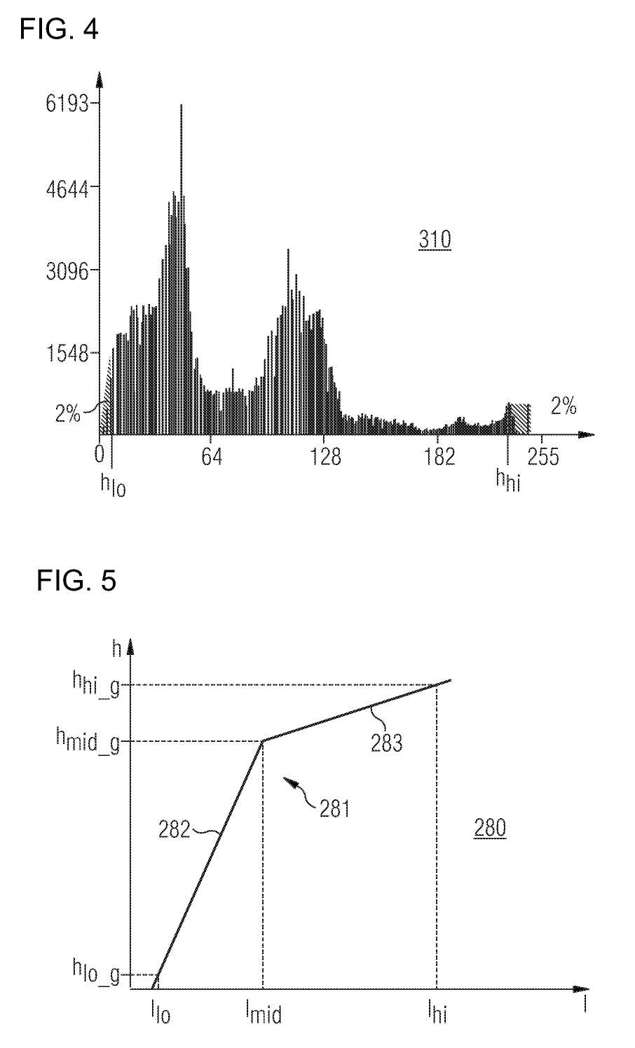

FIG. 4 shows a histogram of matched gray scale values in which the 0.02 and 0.98 quantile match the respective target value,

FIG. 5 shows a lin-log sensitivity characteristic indicating the inflexion point,

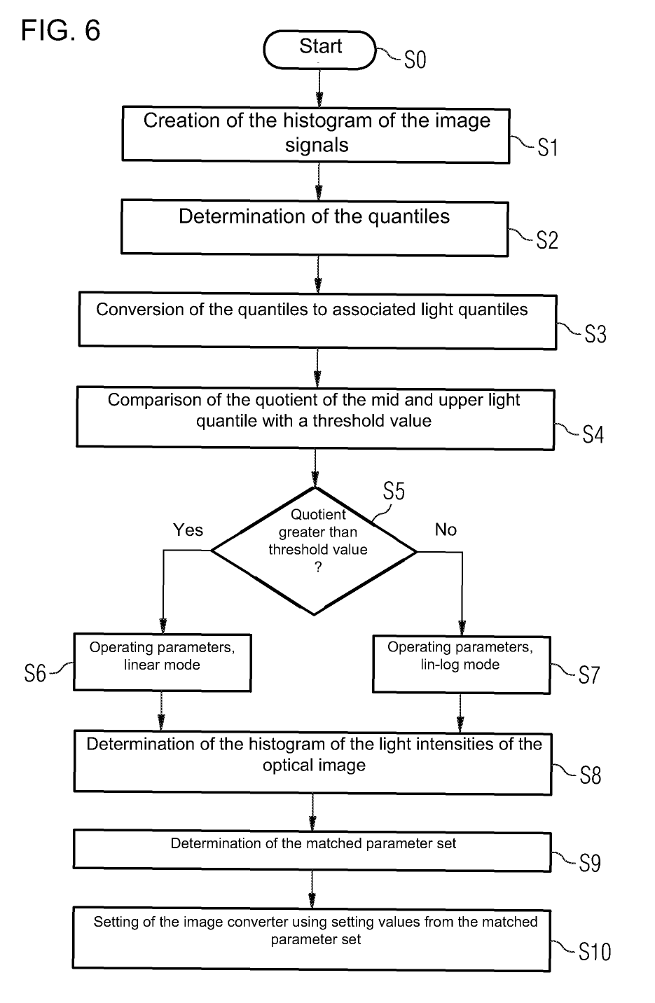

FIG. 6 shows a method for lighting control of a lin-log image converter with the aid of a flow diagram, and

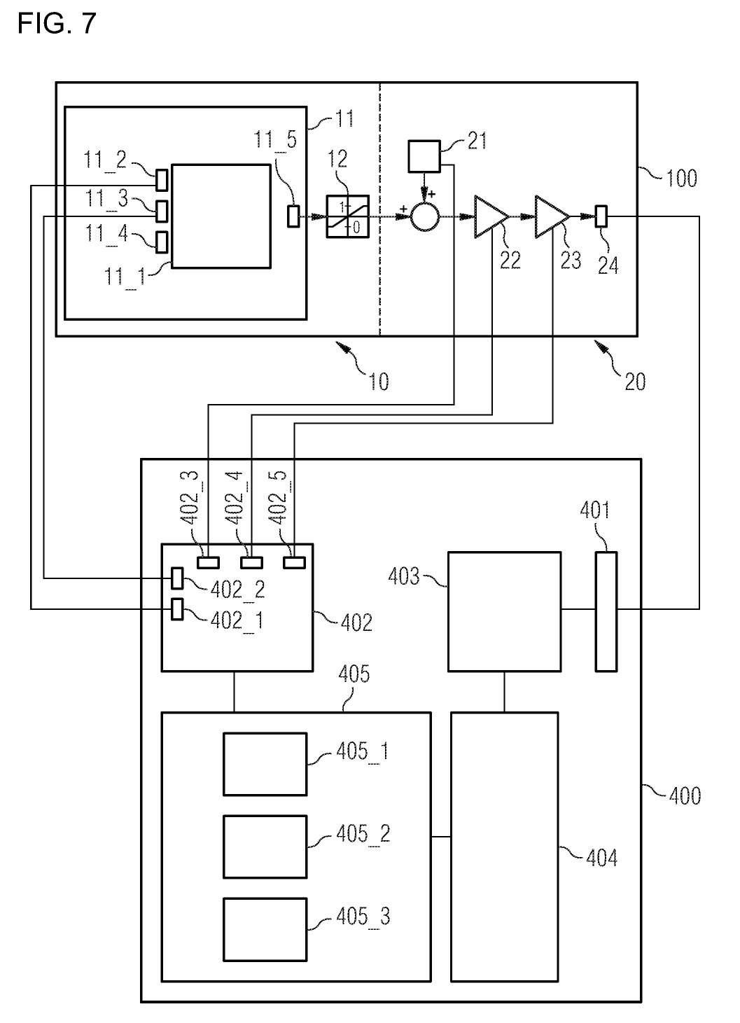

FIG. 7 shows a block diagram of a lighting control device.

FIG. 1 shows an example of a construction of an image converter 100 which can optionally be operated with a lin-log or linear sensitivity characteristic. The image converter has an image conversion mechanism 10 and an amplifier 20 which is connected downstream.

The amplifier 20 converts the output voltage of the image conversion mechanism 10 into gray scales, wherein the conversion can be affected by the settings of the A/D converter (analog-digital converter) 23, the gain (amplification factor) of the VCA (Voltage Controlled Amplifier), whose output-side level can be set by means of a control voltage) 22 and the offset voltage introduced by means of the controllable voltage source 21. The gray scale values are output at the output 24 of the analog-digital converter 23.

In the example presented the image conversion mechanism 10 comprises a CMOS chip 11 with a photosensitive surface 11_1 which is embodied for conversion of an optical image projected onto it into electrical signals which are available for further processing at the output 11_5 of the chip 11. The conversion can be controlled by means of suitable settings which can be effected via corresponding signals at the inputs of the CMOS chip 11 provided for this purpose. In the example of FIG. 1 an input for setting the lighting time 11_2, the operating mode 11_3 (linear or lin-log mode) and the lin-log parameters 11_4 respectively are provided. The restriction of the output signal of the CMOS chip 11 is modeled by the saturation module 12.

As the actual voltage level at output 11_5 of the CMOS chip is not significant to the description of the invention a normalized output voltage U_{c} will be used as the basis hereinafter, with a value range from 0 to 1, with 1 being the saturation voltage of the CMOS chip 11.

The gray scale values h associated with the respective normalized voltages result from the following equation:

h=g_{VCA}g_{AD}(U_{C}+U_{off}) (1)

wherein g_{VCA} denotes the gain of the VCA 22, g_{AD} the gain of the A/D converter 23, U_{C} the normalised output voltage of the CMOS chip 11 and U_{off} the offset voltage of the controllable voltage source 21.

The connection between the normalized output voltage U_{C} of the CMOS chip 11 is given by the following equation in linear mode:

U_{C}=lt₁ (2)

with the normalized light intensity 1 striking the photodiode.

During operation in lin-log mode a sensitivity curve as shown in FIG. 2 is obtained instead of a linear one. The position of the inflection points and the gradients of the sensitivity characteristic are affected by the lin-log parameters U₁₁ (lin-log voltage) and tₗₗ (lin-log time).

The following is obtained for the U_{C} function:

$$\begin{matrix}{U}_{C} = {t}_{I} l for l < \frac{1 - {U}_{11}}{{t}_{11}} \\ and & ( 3 a ) \\ 1 - {U}_{11} + ( {t}_{I} - {t}_{11} ) l for l \geq \frac{1 - {U}_{ll}}{{t}_{11}} & ( 3 b )\end{matrix}$$

The graph 270 in FIG. 2 shows a graphical representation of this function. The U_{C} function represents the sensitivity characteristic 271 of the image converter in lin-log mode. It comprises two characteristic sections 272 and 273, the first characteristic section representing the sensitivity of the image converter at a light intensity below the value given by {(1−U₁₁)/tₗₗ} and the second characteristic section representing the sensitivity of the image converter above the value given by {(1−U₁₁)/tₗₗ}.

To be able to draw conclusions about the light intensity corresponding to a gray scale value at an image converter element of the CMOS chip 11 from the gray scale values output by the image converter 100 equation (1) has to be converted such that the voltage U_{C} pertaining to a gray scale value is obtained at the output of the CMOS chip 11:

$${U}_{C} = \frac{h}{{g}_{VCA} {g}_{AD}} - {U}_{off} \qquad ( 4 )$$

According to equation (2), during operation of the image converter in the mode with linear sensitivity characteristic the light intensity 1 of an image element corresponding to the output voltage U_{C} on the photosensitive surface of the CMOS chip 11 results in:

$$l = \frac{{U}_{c}}{{t}_{I}} \qquad ( 5 )$$

With active lin-log mode the following are obtained with equations (2) and (5):

$$\begin{matrix}l = \frac{{U}_{c}}{{t}_{I}} for {U}_{c} < \frac{{t}_{I}}{{t}_{ll}} ( 1 - {U}_{ll} ) \\ and & ( 6 a ) \\ l = \frac{{U}_{c} + {U}_{ll} - 1}{{t}_{I} = {t}_{ll}} for {U}_{C} \geq \frac{{t}_{I}}{{t}_{ll}} ( 1 - {U}_{ll} ) & ( 6 b )\end{matrix}$$

One aim of lighting control is to utilize the dynamic range of the image converter output as far as possible. This means that the lower gray scale values have optimally low values without there being an excessive number of black image elements, and that the upper gray scale values assume optimally high values without there being an excessive number of saturated (white) image elements. A further aim is an optimally uniform frequency distribution of the gray scale values in a histogram of the image to achieve a high contrast optimally over the entire image.

For this purpose the setting parameters of the image converter 100 are selected such that certain quantiles of the histogram of the gray scale values attain specified target values.

FIG. 3 shows a histogram 300 of the gray scale values of an image, which has been produced by means of the image converter 100 operated in linear mode from an optical image projected onto the photosensitive surface of the CMOS chip. The 0.02 quantile hₗₒ and the 0.98 e quantile hₕᵢ are marked in the histogram. The 0.02 quantile is taken to mean a quantile of the order 0.02 which specifies the gray scale value of the histogram below which 2% of the image elements with lower gray scale values are found. This definition applies analogously to quantiles of a different order. For example the quantile of the order 0.98 (0.98 quantile) specifies the gray scale value above and including which 2% of the image elements with higher or equal gray scale values are found. Also specified in the histogram of FIG. 3 are the target values of the 0.02 quantile hₗₒ_{_{—}}_{g} and the 0.98 quantile hₕᵢ_{_{—}}_{g}. The setting parameters of the imager converter are accordingly firstly matched (while retaining the linear operating mode of the image converter) such that when the optical image is converted again the 0.02 quantile hₗₒ and the 0.98 quantile hₕᵢ attain the target values hₗₒ_{_{—}}_{g} and hₕ_{_{—}}_{g}, as shown in the histogram 310 in FIG. 4.

Saturated image elements, i.e. image elements whose gray scale value corresponds to the maximum value hₘₐₓ, i.e. white, independently of the actual light intensity constitute a problem in this connection. This can mean that it is no longer possible to accurately determine the 0.98 quantile and it corresponds to the maximum gray scale value. To counteract this the 0.98 quantile hₕᵢ is increased as a function of the number of saturated image elements, wherein discontinuities are to be taken into account. If the 0.98 quantile corresponds to the maximum gray scale value hₘₐₓ then a calculation of a corrected 0.98 quantile hₕᵢ according to the following equation has proven to be useful:

$${h}_{hi} = {h}_{max} ( 1 + 5 ( \frac{{n}_{sat}}{n} - 1 + {p}_{hi} ) ) \qquad ( 7 )$$

wherein n is the total number of image elements, nₛₐₜ the number of saturated image elements and pₕᵢ the order of the quantile (0.98 or 98% in the present example). The empirically determined factor 5 results in good control behavior, i.e. quick lighting control that does not overshoot is achieved.

So the quantiles quickly reach their target values in the case of lighting control with a linear sensitivity characteristic, by using the above mathematical model representation of the image converter the underlying light intensities of the optical image can be back-calculated from gray scale values. In other words, the histogram of image signals based on gray scale values is converted with the aid of the above-derived equations into a light intensity histogram of the optical image. This conversion is obtained by inserting equation (4) in equation (5):

$$l = \frac{1}{{t}_{I}} ( \frac{h}{{g}_{VCA} {g}_{AD}} - {U}_{off} ) \qquad ( 8 )$$

The light intensities pertaining to the target values of the 0.02 and 0.98 quantiles can accordingly be determined from the histogram of light intensities calculated using equation (8). From this and by inserting equation (2) in equation (1) the target values for the corresponding quantiles of the gray scale value histogram result in:

hₗₒ_{_{—}}_{g}=g_{VCA(+1)}g_{AD}(lₗₒt_{I(+1)}+U_{off(+1)}) (9)

hₕᵢ_{_{—}}_{g}=g_{VCA(+1)}g_{AD}(lₕᵢt_{I(+1)}+U_{off(+1)}) (10)

The new parameter set of setting values t_{I (+1)}, g_{VCA (+1)} and U_{off (+1)} of the image converter, matched to the light intensity distribution of the optical image, can be determined herefrom.

As equation system (9) only comprises two equations for three setting values to be determined, an explicit solution can only be found for one setting value. A second solution is only possible for a combination of the other two setting parameters. It has proven to be advantageous to resolve equation system (9) according to the product of integration time and gain as this product controls the spacing between hₗₒ and hₕᵢ. The following is therefore obtained from equations (9):

$$p = {t}_{I ( + 1 )} {g}_{VCA ( + 1 )} = \frac{{h}_{lo\_g} - {h}_{hi\_g}}{{g}_{AD} ( {l}_{hi} - {l}_{lo} )} \\ {U}_{off ( + 1 )} = \frac{{h}_{lo\_g}}{{g}_{VCA ( + 1 )} {g}_{AD}} - {l}_{lo} {t}_{I ( + 1 )} \qquad ( 10 )$$

The equation for the new integration time and the new gain can therefore be written relative to the old integration time and old gain. This is of interest insofar as it proves that uncertainties in the image converter setting values do not have an effect on this equation because knowledge of the light intensities is not necessary when determining the new values relative to the old ones:

$$p = {t}_{I ( + 1 )} {g}_{VCA ( + 1 )} = \frac{{h}_{lo\_g} - {h}_{hi\_g}}{{h}_{io} - {h}_{hi}} {t}_{I} {g}_{VCA} \qquad ( 11 )$$

To determine t_{I(+1)} and g_{VCA(+1)} it is firstly decided whether high or low gain values are preferred. If low gain values are preferred the method for determining the two values first of all starts with the lowest admissible gain value and checks whether the integration time associated therewith lies within the admissible interval. If an excessively long integration time results, the gain is increased to the next higher value, etc. until the associated integration time lies within the admissible interval or the gain reaches the highest admissible value. An hysteresis of a gain stage can be used to avoid frequent changing of the gain value. If high gain values are preferred, the method starts with the maximum admissible gain value.

The offset voltage can be calculated in accordance with the second equation of equation set (10) following calculation of the integration time. An hysteresis can also be incorporated here to avoid a non-linear oscillation between two offset values.

With an image with a constantly high proportion of high gray scale values the target value hₗₒ_{_{—}}_{g} for the 0.02 quantile sometimes cannot be reached owing to restrictions to the offset voltage setting. In this case, to increase the influence of the offset voltage, the gain can be increased and the lighting time reduced. To illustrate this correlation the representation of the gray scale values in equation system (9), i.e.

h=g_{VCA}g_{AD}lt_{I}+g_{VCA}g_{AD}U_{off} (12)

is illustrated with a changed gain g_{VCA}_{_{—}}ₗ setting and integration time t_{I}_{_{—}}ₗ and the restricted offset voltage U_{off}_{_{—}}ₘᵢₙ

h=g_{VCA}_{_{—}}ₗg_{AD}lt_{I}_{_{—}}ₗ+g_{VCA}_{_{—}}ₗg_{AD}U_{off}_{_{—}}ₘᵢₙ (13)

The same gray scale value is achieved after both settings if

$${g}_{VCA\_ 1} = {g}_{VCA} \frac{{U}_{off}}{{U}_{off\_min}} ; {t}_{I\_ 1} = \frac{{g}_{VCA}}{{g}_{VCA\_ 1}} {t}_{I} \qquad ( 14 )$$

When the gain is increased it must however be borne in mind that the minimal integration time must not be undershot, so the condition

$${g}_{VCA\_ 1} < {g}_{VCA} \frac{{t}_{I}}{{t}_{I \_min}} \qquad ( 15 )$$

should be observed. An additional reason for not increasing the gain too much is that a grainy image is obtained even where there is sufficient light intensity. After calculating the offset voltage it should be checked whether the integration time needs to be matched. Equation (11) assumes that the histogram of the future image has the lower quantile hₗₒ at hₗₒ_{_{—}}_{g}. If this is not the case, because for example the offset voltage is restricted or cannot be sufficiently finely set, the histogram can be shifted to higher gray scale values. This shifting can be corrected by means of recalculation of the integration time.

The integration time is corrected in such a way that the 0.98 quantile lₕᵢ of the light intensity histogram is transformed into the target 0.98 quantile hₕᵢ_{_{—}}_{g} of the gray scale values histogram. Using the known values for the offset and gain the new integration time can be determined according to the following equation:

$${t}_{I\_l} = \frac{\frac{{h}_{hi\_g}}{{g}_{VCA\_l} {g}_{AD}} - {U}_{off}}{{l}_{hi}} \qquad ( 16 )$$

With irregular distribution of the light intensities in the histogram of the optical image lighting control as described above leads, with a linear sensitivity characteristic, to low image contrasts which mean that it is no longer possible to discern any structures at all, primarily in the dark areas of the image if the bright areas without saturation are converted. Therefore image conversion, primarily if only small areas of the optical image have high light intensities, should be performed using a lin-log sensitivity characteristic. As stated above, a sensitivity characteristic defined in sections and having different gradients, i.e. different sensitivities, is used in this connection.

Without restricting the generality the method will be described hereinafter with reference to a lin-log sensitivity characteristic defined in two sections. The setting values for an image conversion defined in a plurality of sections are analogously determined therefrom.

The determination as to whether the distribution of the light intensities in the optical image is uniform enough for an image conversion with a linear sensitivity characteristic, or whether the non-uniformities in the light intensity distribution require a lin-log sensitivity characteristic defined in sections is made using an additional quantile or, in the case of a lin-log characteristic defined in more than two sections, using a plurality of additional quantiles, with these being converted into light intensities and being compared with a respective threshold value associated with them.

With a lin-log characteristic defined in two sections it has proven to be expedient, in particular if only small image areas are brightly lit, after determining the 0.7^{th} quantile h_{mid}, to convert this by means of the camera model defined via the equations, into a light value h_{mid}. hₕᵢ is analogously converted into lₕᵢ. l_{mid}/lₕᵢ is then compared with threshold value h_{Thresh}=0.5. Other quantiles and threshold values may of course be used depending on the situation. In particular it is possible to determine both the order of the quantile and the threshold value dynamically, i.e. derived from the gray scale distribution of the image histogram itself. Determination of the 0.7^{th} quantile will be assumed as the decision criterion hereinafter, without restricting the generality, however.

If the quotient is less than the threshold value 0.5, 70% of the image elements have a light value in the lower half of the dynamic range of the scene considered. In this case the image should be converted with a lin-log characteristic whose sensitivity is shown in FIG. 5.

In principle a quantile with an order between the order of the lower quantile and the order of the upper quantile must be converted into light for each inflection point of the lin-log characteristic as above and be compared with a threshold value. If the value of the respective quotient is lower than the respectively associated threshold value the image converter is operated in lin-log mode with an inflection point of the sensitivity characteristic associated with the respective quantile.

In the examples given above the lower quantile was always assumed to have an order of 0.02 and the upper quantile an order of 0.98 as these orders have proven expedient if only a small area of the image is very bright. The described lighting correction is not restricted to quantiles of this order, however. Instead quantiles of a different order may also be used whose values can also be determined in particular as a function of a specific use, for example use of the image converter in driving assistance systems of motor vehicles, or else dynamically as a function of the gray scale distribution in the image.

Graph 280 in FIG. 5 shows a lin-log sensitivity characteristic 281 based on the light intensity of the optical image which results after matching the lighting control on the basis of an additional, mean quantile. Back-calculation of the gray scale value distribution of the image to the distribution of the light intensities of the optical image on the photosensitive surface 11_1 of the image converter takes place as specified above for the lighting control with linear sensitivity characteristic.

The aim of lighting control is for the mid quantile h_{mid} to match the threshold value, while the lower quantile hₗₒ and the upper quantile hₕᵢ still tally with their respective target specifications hₗₒ_{_{—}}_{g} and hₕᵢ_{_{—}}_{g}. To determine the inflection point of the sensitivity characteristic the light intensity l_{mid} corresponding to the threshold value hTₕᵣₑₛₕ is calculated by back-calculation of the gray scale value distribution to the light intensity distribution of the optical image.

The linear parameters of this sensitivity characteristic 281 are calculated, as previously described for lighting control with a linear sensitivity characteristic, with hₕᵢ and hₕᵢ_{_{—}}_{g} being replaced by h_{mid} and h_{mid}_{_{—}}_{g}. The lin-log time tₗₗ is set as a function of the gradient of the characteristic between the light intensities l_{mid} and lₕᵢ and the integration time. To obtain the gradient of the characteristic the target quantiles must be divided by the gain factors, so the difference between the integration time t_{I} and the lin-log time tₗₗ may be depicted:

$${t}_{I} - {t}_{ll} = \frac{{h}_{hi\_g} - {h}_{mid\_g}}{{g}_{VCA} {g}_{AD} ( {l}_{hi} - {l}_{mid} )} , \qquad ( 17 )$$

from which

$${t}_{ll} = {t}_{I} - \frac{{h}_{hi\_g} - {h}_{mid\_g}}{{g}_{VCA} {g}_{AD} ( {l}_{hi} - {l}_{mid} )} \qquad ( 18 )$$

is obtained for setting the lin-log time tₗₗ.

The lin-log voltage U₁₁ is calculated following calculation of the lin-log time. The (normalized) output voltage of the CMOS chip U_{C} at the transition from the first to the second characteristic section of the lin-log characteristic results firstly from equations (3a) and (3b) and secondly from the mid target quantile h_{mid}_{_{—}}_{g} via equation (4). By equalizing both determinations of the output voltage U_{C} the following is obtained:

$$\frac{{t}_{I}}{{t}_{ll}} ( 1 - {U}_{ll} ) = \frac{{h}_{mid\_g}}{{g}_{VCA} {g}_{AD}} - {U}_{off} \qquad ( 19 )$$

By using equation (18) the following results for the lin-log voltage U₁₁:

$${U}_{ll} = 1 - \frac{{t}_{ll}}{{t}_{I}} ( \frac{{h}_{mid\_g}}{{g}_{VCA} {g}_{AD}} - {U}_{off} ) \qquad ( 20 )$$

In many image converters the lin-log voltage can only be input in discrete values. To prevent l_{mid} being displaced into the non-linear range of the characteristic the lin-log voltage calculated according to equation (20) is always rounded down to the next lower available value. The lin-log time tₗₗ has to be re-calculated in accordance with the rounded-down value of the lin-log voltage. For this purpose the gradient of the second sensitivity characteristic section 283 between the inflection point (l_{mid}, h_{mid}_{_{—}}_{g}) of the characteristic and the point (lₕᵢ, hₕᵢ_{_{—}}_{g}) is used, from which the following equation is obtained:

$${t}_{I} - {t}_{ll} = \frac{{U}_{C\_hi \_g} - \frac{{t}_{I}}{{t}_{ll}} ( 1 - {U}_{ll} )}{{l}_{hi} - \frac{1 - {U}_{ll}}{{t}_{ll}}} . \qquad ( 21 )$$

From this

$${t}_{ll} = \frac{{t}_{I} {l}_{hi} + 1 - {U}_{ll} - {U}_{C\_hi \_g}}{{l}_{hi}} \qquad ( 22 )$$

is obtained for the lin-log time tₗₗ.

FIG. 6 shows the fundamental steps of a method for lighting control of a lin-log image converter 100 on the basis of three quantiles and back-calculation of the frequency distribution of the image signals to the frequency distribution of the light intensities according to the above-described mathematical model of a lin-log image converter.

Following the start of the method in step S0 a frequency distribution of the image signal values in the optical image converted by the lin-log image converter is firstly created in step S1. In the following step S2 lower, mid and upper quantiles are determined from the histogram of this frequency distribution. The order of the mid quantile is greater than the order of the lower quantile and less than the order of the upper quantile in this case. In step S3 the quantiles are converted into the associated light quantiles with the aid of the mathematical camera model. In step S4 the quotient of the mid and upper light quantiles are compared with a threshold value and in step S5 it is checked whether the quotient is greater than the threshold value. If the quotient is greater than the threshold value the operating mode setting value of the matched parameter set is set in step S6 to the operating parameter of the image converter for linear mode. Otherwise the operating mode setting value is set in step S7 to the operating parameter for the lin-log mode of the image converter. In step S8 the above-described determination of the frequency distribution of the light intensities of the optical image is performed, on the basis of which the parameter set matched for optimized lighting is determined in step S9. Finally the image converter is set in step S10 with the aid of the matched parameter set, whereupon the method continues with step S1.

FIG. 6 shows a lighting control device 400 for matching the sensitivity characteristic of an image converter to the light intensity distribution of an optical image projected onto the photosensitive surface of the image converter. The device 400 comprises a signal input 401 for receiving the image output signals of the image converter 100 and a signal output 402 for outputting signals to control the image converter 100. The signal output 402 includes a plurality of channels corresponding to the setting values of the image converter 100 to be controlled. In the illustrated example these are the channels for controlling the lighting time 402_1, the lin-log parameter 402_2, the offset voltage 402_3, the VCA gain 402_4 and the A/D converter gain 402_5.

The histogram system 403 is embodied to create a frequency distribution of the image signals received by the image converter 100 via the signal input 401. On the basis of this frequency distribution the lower quantile, the upper quantile and, if required, the mid quantile or additional mid quantiles are determined in the quantile determining system 404, and are used in the setting calculation system 405 to create a matched parameter set of setting values of the image converter 100. The parameter set created using the quantiles of the frequency distribution of the image signals is transmitted to the signal output 402, wherein the setting values of the parameter set are transmitted via the channels, associated with the respective setting values, to the image converter 100.

The setting calculation system 405 is preferably embodied to create a setting value for setting the operating mode of the image converter 100 which allows optional operation of the image converter in linear or lin-log mode. Furthermore, the setting calculation system 405 is embodied to create setting values for the offset voltage of the controllable voltage source 21, the lighting time and the gain of the image converter 100.

In a further embodiment the setting calculation system 405 includes a back-calculation device 405_1 which is embodied for calculating the light intensity distribution within the optical image that is used as the basis of the histogram of the image signals. The setting calculation system 405 can, moreover, comprise a threshold value comparator 405_2 which is embodied to compare a quotient of quantiles converted into light with a threshold value according to a method as designed above. The result of the threshold value comparison forms the basis of the creation of the operating mode setting value performed in the operating mode setting mechanism 405_3.

Reference is made to the fact that FIG. 6 shows only the components of the system 400 for lighting control of an image converter which are required for an understanding of the present invention. The depiction of additional components required for operation of the device or determining the additional functional scope thereof has been omitted in the interest of a clear diagram. These components are nevertheless assumed to exist.

The method presented and the system presented can be implemented by means of software which is designed to be executed on a data processing system. Execution of the software brings about execution of the method on the data processing system such that the system 400 is adapted to the data processing system. The software can assume an independent form in the manner of a computer program product, the computer program product comprising a series of physically distinguishable states which can be read and executed by a data processing system and embody the instructions of the software.

The presented lighting control by means of determination of quantiles on the basis of a frequency distribution of the image gray scale values allows extremely quick matching of the setting values of the image converter to the distribution of the light intensities in an image to be converted. In practice the image following the image which is used as the basis of lighting control is already converted with optimum contrast in half of all cases. As in the case of saturated image elements correct conclusions cannot be drawn about the light intensity prevailing at these points in the optical image, the optimum lighting setting is achieved in about 30% of cases only after the second successive image, in about 20% of cases only after the third successive image or a subsequent successive image, but even in these cases matching of the lighting setting is significantly quicker than with conventional methods.

The use of three or more quantiles also allows quick matching of the HDR functionality (High Dynamic Range Functionality) of an HDR camera to the actually prevailing light conditions. Matching takes place via suitable fixing of the inflection point(s) of the sensitivity characteristic and the gradients of the individual characteristic sections. This means the dynamic of the camera can be better utilized and darker image elements also have satisfactory contrasts. Furthermore the image contrast is optimized by control of the offset U_{off}.

### LIST OF REFERENCE NUMERALS

10 image conversion mechanism
11 CMOS chip
11_1 photosensitive surface
11_2 input for lighting time
11_3 input for operating mode
11_4 input for lin-log parameters
11_5 output CMOS chip
12 saturation module
20 amplifier
21 controllable voltage source
22 VCA
23 analog-digital converter
24 output of analog-digital converter
100 image converter
270 graph of a lin-log characteristic
271 lin-log sensitivity characteristic
272 first characteristic section of the lin-log characteristic
273 second characteristic section of the lin-log characteristic
280 graph of a lin-log characteristic for matching the lighting control
281 lin-log sensitivity characteristic for matching the lighting control
282 first characteristic section for matching the lighting control
283 second characteristic section for matching the lighting control
300 histogram of the image gray scale values before matching the lighting control
310 histogram of the image gray scale values after linear matching of the lighting control
400 lighting control device
401 signal input
402 signal output
402_1 output channel for lighting time
402_2 output channel for lin-log parameters
402_3 output channel for offset voltage
402_4 output signal for VCA gain
402_5 output channel for A/D converter gain
403 histogram system
404 quantile determining system
405 setting calculation system
405_1 back-calculation system
405_2 comparator
405_3 operating mode setting mechanism
S0-S9 method steps

1-16. (canceled)

17. A method of adapting a sensitivity characteristic of an image converter to a light-intensity distribution of an optical image projected onto a photosensitive surface of the image converter, the method which comprises:
creating a frequency distribution of image signal values in the optical image converted by the image converter;
determining at least one first quantile and a second quantile of the frequency distribution of the image signal values, with an order of the second quantile being higher than an order of the first quantile;
determining a frequency distribution of light intensities on the photosensitive surface of the image converter by using a relationship, determined by a current parameter set of setting values of the image converter, between light intensities on the photosensitive surface and the image signal values output by the image converter;
creating an adapted parameter set of setting values of the image converter defined to match the first quantile of the frequency distribution of the image signal values resulting from the determined frequency distribution of the light intensities to one target value and to match the second quantile of the frequency distribution to a second target value; and
setting the setting values corresponding to the adapted parameter set.

18. The method according to claim 17, wherein the adapted parameter set comprises at least one operating mode setting value for setting an operating mode of the image converter.

19. The method according to claim 17, wherein the adapted parameter set comprises values for setting offset, lighting time, and gain of the image converter.

20. The method according to claim 17, which further comprises determining an operating mode setting value on the basis of at least one additional quantile.

21. The method according to claim 20, wherein an order of the at least one additional quantile is higher than the order of the first quantile and lower than the order of the second quantile.

22. The method according to claim 17, wherein the step of determining the frequency distribution of the light intensities on the photosensitive surface of the image converter comprises determining the frequency distribution of the light intensities based on a mathematical model via the conversion of a light intensity into an image signal using the current setting values of the image converter as parameters.

23. The method according to claim 22, which comprises generating the adapted parameter set of setting values of the image converter from a previously determined frequency distribution of the light intensities by using the mathematical model as a basis.

24. The method according to claim 22, which further comprises the following method steps:
determining an operating mode setting value on the basis of at least one additional quantile;
comparing a quotient of the light intensity determined for the at least one additional quantile and the light intensity determined for the second quantile with a threshold value; and
if the at least one quotient is greater than the threshold value, switching the image converter into a first operating mode, and
if the at least one quotient is less than or equal to the threshold value, switching the image converter into a second operating mode.

25. The method according to claim 24, wherein the image converter has a linear sensitivity characteristic in the first operating mode.

26. The method according to claim 24, wherein the image converter has a sensitivity characteristic in the second operating mode with at least two linear characteristic segments with different gradients.

27. The method according to claim 21, wherein the adapted parameter set comprises values for setting lin-log timing and lin-log voltage of the image converter determined on the basis of the at least one additional quantile and the second quantile.

28. The method according to claim 21, which comprises determining the values of the adapted parameter set for setting offset, lighting time, and gain of the image converter based on the first quantile and the at least one additional quantile.

29. A device for matching a sensitivity characteristic of an image converter to a light-intensity distribution of an optical image projected onto a photosensitive surface of the image converter, the device comprising:
a histogram device for creating a frequency distribution of image signal values of the optical image converted by the image converter;
a quantile determining device for determining at least two quantiles of the frequency distribution of the image signal values; and
a setting calculation system for creation of an adapted parameter set of setting values of the image converter on a basis of the quantiles of the frequency distribution determined by said quantile determining device, said setting calculation system including a back-calculation system configured to determine the frequency distribution of the light intensities on the photosensitive surface of the image converter;
wherein said histogram device, said quantile determining device, and said setting calculation system are commonly configured to carry out the method according to claim 17.

30. The device according to claim 29, wherein said setting calculation system comprises an operating mode setting mechanism for setting an operating mode of the image converter.

31. The device according to claim 29, wherein said setting calculation system comprises a comparator for comparing at least one quotient of a light intensity determined for an additional quantile and a light intensity determined for the second quantile with a threshold value.

32. A computer program product for matching a sensitivity characteristic of an image converter to a light intensity distribution of an optical image projected onto a photosensitive surface of the image converter, the computer program product comprising:
a series of physically distinguishable states in computer-readable and computer-executable language which, when corresponding instructions are executed on a data processing system, carry out the method according to claim 17.

33. A computer program product for matching a sensitivity characteristic of an image converter to a light intensity distribution of an optical image projected onto a photosensitive surface of the image converter, the computer program product comprising:
a series of physically distinguishable states in computer-readable and computer-executable language which, when corresponding instructions are executed on a data processing system, embody the device according to claim 29.
